(19) United States
(12) Patent Application Publication
(10) Pub. No.: US 2010/0088437 A1
(43) Pub. Date: Apr. 8, 2010

(54) INFINIBAND ADAPTIVE CONGESTION CONTROL ADAPTIVE MARKING RATE

(75) Inventor: Eitan ZAHAVI, Zichron Yaakov (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: MELLANOX TECHNOLOGIES LTD, Yokneam (IL)

(21) Appl. No.: 12/245,814

(22) Filed: Oct. 6, 2008

(51) Int. Cl. G06F 13/00

(52) U.S. Cl. 710/36

(57) ABSTRACT

A device and a method for optimizing data transfer rate in an InfiniBand fabric is provided where a various number of transmitting devices aim data packets to a single receiving device or through a common link. The method which is implemented in an InfiniBand switch includes marking of packets in a rate corresponding to centrally configured marking rate, determination of the current number of data flows between the input ports and the output port of the switch and marking the data packet with Forward Explicit Congestion Notification according to an adaptive value of marking rate which depends on the initial value of the marking rate and is inversely proportional to the number of data flows.

### FIELD AND BACKGROUND OF THE INVENTION

This invention relates to computer technology, more particularly to computer networks and most specifically to reducing congestion in InfiniBand-based data transmission systems.

The InfiniBand™ (IB) is an exceptionally high-speed, scalable and efficient I/O technology

The (IB) architecture (IBA) is based on I/O channels which are created by attaching adapters which transmit and receive through InfiniBand switches which utilizes both copper wire and fiber optics for transmission.

This interconnect infrastructure of adapters and switches, is called a “fabric”.

The IBA is described in detail in the InfiniBand Architecture Specification, release 1.0 (October 2000), which is incorporated herein by reference. This document is available from the InfiniBand Trade Association at www.infinibandta.org.

IB is a lossless network in which a data packet is not sent to the input of an interconnecting switch unless it can be assured that it can be delivered promptly and at its entirety to its destination port, on the other side of the link, and which in order to maintain its lossless property uses a fast, hardware implemented mechanism of link-level flow control.

When networks are driven closer to their saturation point some “hot spots” may be created where traffic aiming to flow into a fabric link exceeds its capacity. The link-level flow control mechanism prevents packet drop in these cases but since data is prevented from being sent into the “hot spot” more and more buffers are being filled causing a condition known as “congestion spreading”.

A “hot spot” is a specific link in the IB fabric to which enough traffic is directed from other nodes that the link or destination host is over loaded and begins backing up traffic to other nodes.

Congestion spreading occurs when backups on overloaded links or nodes curtail traffic in other, otherwise unaffected channels.

Tree saturation spreads very far too quickly for any software to react in time to the problem, the problem also dissipates slowly since all the queues involved must be emptied, hence a hardware solution to congestion spreading is required.

Earlier attempts to mitigate the congestion spreading assumed an a-priory knowledge of where the hot spot was, an assumption which is unrealistic in light of the endless variety of traffic patterns and network topologies.

Later methods for elevation of hot spots and congestion spreading in InfiniBand are described in U.S. Pat. No. 7,000,025 to A. W. Wilson.

Current methods for handling congestion rely on an IBA Congestion Control Architecture (CCA) described in Annex 10 of the IBA specification 1.2 which includes standard messages and hardware mechanisms in the IB fabric switches and hosts. The invited paper (including its references) “Solving Hot Spot Contention Using InfiniBand Architecture Congestion Control” by G. Pfister et al, Proceedings of the 13th Symposium on High Performance Interconnects 2005, volume issue 17-19, Aug. 2005, page(s): 158-159, both of which are incorporated here by reference, demonstrates how the IBA CCA can resolve congestion, but concludes that a different set of CCA parameters should be loaded into the fabric devices to handle different traffic patterns.

In order to appreciate the present invention, the way in which the congestion control operates will now briefly be described:

The main idea which underlies the CCA is to throttle the data transfer rate (transmitting rate reduction) of source servers to a destination server via a saturated link. Such throttling is achieved by producing a delay between packets in the data transmission whenever a source server “is noticed” in a mechanism that will be detailed below, that congestion has been detected in a given output of its interconnecting switch. On the other hand, when certain duration of time has passed in which the suppressed sending server has not been notified on congestion, its transmission rate recovers. Hence, notification of detected saturation in a port f an interconnecting switch is a key factor in the appropriate operation of the congestion control closed loop.

Implementation of such notification includes the switch marking of out going packets to the receiving server by activating a bit in the base transport header of the packet. One fundamental parameter which is needed for the appropriate operation of the congestion control, so as to achieve an effective transmission quenching from one hand and avoid throughput losses from the other hand, is an optimal marking rate.

Currently, outgoing packets are marked according to a “Marking Rate” as specified by special congestion control parameters setting packet received by the switch and sent by the Congestion Control Manager (CCM) software which runs on some server.

Pfister et al. pointed out that congestion control operates satisfactorily if and only if marking parameters are properly set and suggest to apply a uniform set of parameters for the marking which are to be pre-calculated given the average network load and the number of source host channel adaptars (HCA's) which are sending data to the same node. The “025” patent suggests packets marking according to a probability which corresponds to a percentage of time that the congested output buffer of a switch buffer is overloaded with data packets.

It is however not feasible that marking rate (the mean number of packets between marking) needed for efficient congestion quenching should be independent on the actual traffic pattern in the network.

No prior art method addresses explicitly the challenge of contradicting marking requirements in the case of encountering various traffic patterns such as e.g. that of “few to one” (when only a small number of nodes communicate with a single node) and “all to one” (when all the nodes communicate with a single node).

The present invention fulfills such a need and carries additional advantages.

### SUMMARY

The present invention is a method and a device for automatic adaptive marking of data packets with a Forward Explicit Congestion Notification (EFCN) needed for effective congestion control under various conditions of traffic patterns.

In accordance to the present invention there is provided a method for adaptive congestion control in an InfiniBand (IB) fabric, the fabric including a plurality of transmitting devices that transmit packets of data to a receiving device through a switch, comprising: (a) sending data from at least one transmitting device among the plurality of the transmitting devices via at least one input port of the switch, said data is transferred to an output buffer of an output port of the switch which is connected to the receiving device, (b) monitoring continuously for data congestion in said output buffer of said switch, (c) deducing a value for an initial marking rate (MRᵢ) by a Congestion Control Manager which is included in the switch, (d) determining each pre-determined time period the number of data flows-N_{F} to said output buffer of said switch, (e) calculating a value for an adaptive marking rate (AMR), said value of AMR depends on said value of MRᵢ and on N_{F,} (f) associating a BECN to said marked data by the receiving device and sending said BECN to said transmitting devices from which the data has been sent respectively, and (g) adjusting the data transmitting rate of each of the transmitting devices in accordance to their acceptance of said BECN.

In accordance to the present invention there is provided a switch in an InfiniBand (IB) fabric connecting between a plurality of transmitting devices and at least one receiving device comprising of: (a) a plurality of input ports to which the transmitting devices are connected and at least one output port to which the receiving device is connected, (b) a Congestion Control Manager (CCM) to determine an initial value to a marking rate (MRᵢ), (c) a mechanism which determines at each selected time interval, the number of data flows N_{F} between said plurality of input ports and said at least one output port and which calculates accordingly an adaptive value for said marking rate (AMR), (d) a data packet FECN marker which marks data in accordance to said AMR value, (e) a second mechanism to deliver both marked and unmarked said incoming data packets to said receiving device and, (f) a third mechanism to return a BECN generated due to said marked packets to the transmitting device among said plurality of transmitting devices from which said data packet originated.

In accordance with the present invention there is provided an InfiniBand system for data transfer comprising: (a) at least one transmitting device among a plurality of transmitting devices which transmit data packets, (b) at least one receiving device which receives said transmitted data packets, and (c) at least one switch connecting between said plurality of transmitting device and said at least receiving device, wherein said switch upon detecting data congestion identifies the number of flows N_{F} between said plurality of transmitting devices and said at least one receiving device and marks said incoming data packets with a marking rate having a value of which is inversely proportional to N_{F}.

It is the aim of the present invention to remove congestion efficiently in a data transfer system.

It is an additional aim of the present invention to provide a stable data transfer system.

It is another aim of the present invention to provide a fast data transfer system.

Other advantages and benefits of the invention will become apparent upon reading its forthcoming description which is accompanied by the following drawings:

### BRIEF DESCRIPTION OF THE DRAWINGS

FIG. 1 shows a block diagram of the situation of N transmitting devices to one receiving device in accordance to the present invention in an InfiniBand data transfer system.

FIG. 2 shows a flow chart showing the marking method in accordance to the present invention.

FIG. 3 shows a block diagram of an InfiniBand switch in accordance to the present invention.

FIG. 4A shows results of an experiment of data packet transfer in a “2 to 1” situation without the present invention.

FIG. 4B shows results of an experiment of data packet transfer in a “32 to 1” situation without the present invention.

FIG. 4C shows the results of experiment of data packet transfer in a “2 to 1” in accordance with the present invention and

FIG. 4D shows the results of experiment of data packet transfer in a “32 to 1” in accordance with the present invention.

### DETAILED DESCRIPTION OF THE EMBODIMENTS

The present invention is a method and a device for automatic adaptive marking of data packets with Forward Explicit Congestion Notifications (EFCN) needed for effective congestion control under various conditions of traffic patterns.

The present embodiments herein are not intended to be exhaustive and to limit in any way the scope of the invention; rather they are used as examples for the clarification of the invention and for enabling of other skilled in the art to utilize its teaching.

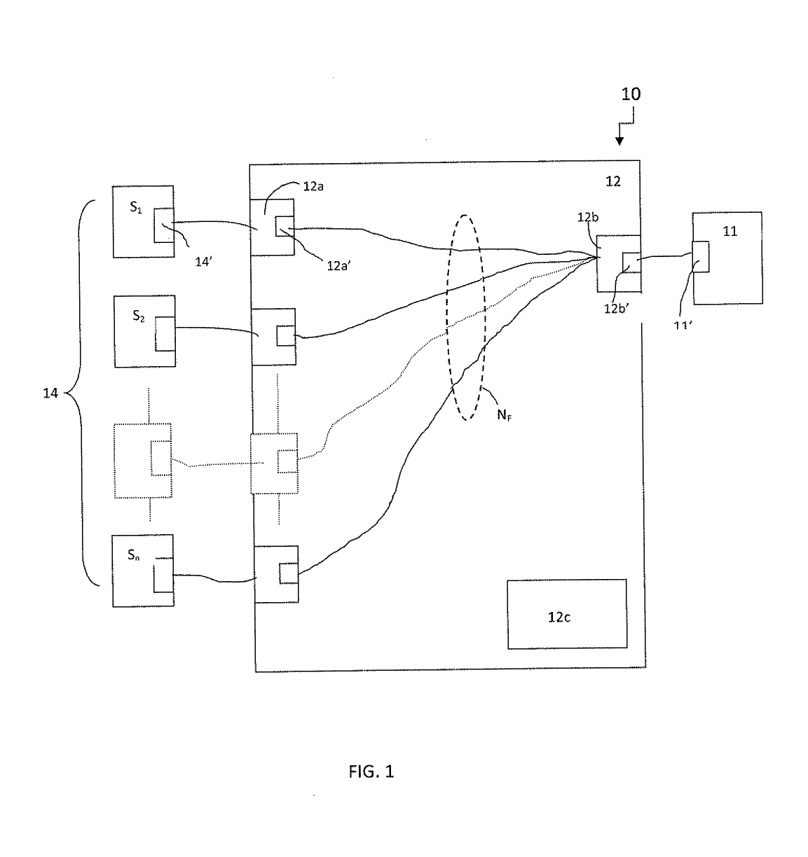

FIG. 1 illustrates the mechanism in which the IB Congestion Control Architecture operates in relation to the present invention.

In an IB fabric 10 of FIG. 1, a single destination server (which is termed hereinafter synonymously—a receiving server) 11 is linked via an IB switch 12, to a plurality 14 of N source servers S₁ to Sₙ (which are termed hereinafter synonymously—transmitting servers), e.g. but not limited to N=20.

Transmitting servers 14 are connected to switch 12 through a set 12a of corresponding N input ports, each having an input buffer 12a′.

Receiving server is connected to switch 12 through an output port 12b having an output buffer 12b′. Switch 12 includes also a firmware Congestion Control Agent (CCAg) 12c

Destination server 11 includes a network interface card such as 11′ having a firmware or hardware with processing logic to process received data packets and to detect marked data and to generate a Backward Explicit Congestion Notification (BECN) to be sent back to the appropriate source server in 14.

Each source server S₁-Sₙ includes a network interface card such as 14′ having firmware or hardware with processing logic which enables it to reduce the server data transmitting rate in accordance to the BECN methodology of the CCA.

Number of data flows N_{F} is defined as the number of unique combinations of destination server 11 and each source server Sᵢ among plurality of source servers 14 across which data packets are transferred.

Congestion is detected in switch 12, when a relative threshold of packets occupancy at buffer 12b′, which was set by CCM unit 12c has been exceeded.

When congestion is detected in switch 12, the switch turns on a bit of a base transport header present in every IBA data packet (not shown in FIG. 1) a procedure which is called marking with Forward Explicit Congestion Notification (FECN).

Not every packet has to be marked. The value which provides the mean number of packets between marking eligible packets with FECN is defined hereinafter as marking rate (MR).

Thus, marking rate has a value of between 0 (every packet is marked) to about 2¹⁶ which corresponds to no marking at all.

When the marked data packets arrives to interface card 11′ of destination server 11, interface card 11′ responds back to the source server among plurality 14 by activating and returning a different bit set in the received packet, a procedure which is called Backward Explicit Congestion Notifications (BECN).

When a source server e.g. S₁ receives a BECN it responds by throttling its transmitting rate, which reduces congestion due to this source server.

A point to emphasis which is relevant to the present invention is the fact that in accordance to the CCA specification CCAg units do not distinguish upon marking between the data packets of different sources and the same marking rate is applied to the packets regardless their origin.

Hence on the average, the rate of BECN's arrival to each source server is about inversely proportional to the number of actual transmitters.

The idea which underlies the present invention is that the effect of varying the number of transmitting devices on the BECN accepting rate of each device has to be compensated by an adaptive marking rate. This idea is realized as follows:

When the marking rate (MR) as determined initially for switch 12 is MRᵢ and a hardware in switch 12 identifies the current number of data flows-N_{F}, an adaptive marking rate (AMR) will be allocated by a mechanism which will be detailed below in which AMR=MRᵢ/N_{F}.

The destination server will recognize marked packets and will associate to each marked package a BECN and return it to the packet original sending server.

This returned BECN may be piggy backed on a regular acknowledgment notification (ACK) or a special congestion notification.

Then, each transmitting server among 14 reduces its data injection rate in accordance to the way it was programmed to respond to returned BECN.

After an adjustable period of time, the number of flows is monitored again and accordingly a new value will be assigned to N_{F} which results with a new marking rate and so on.

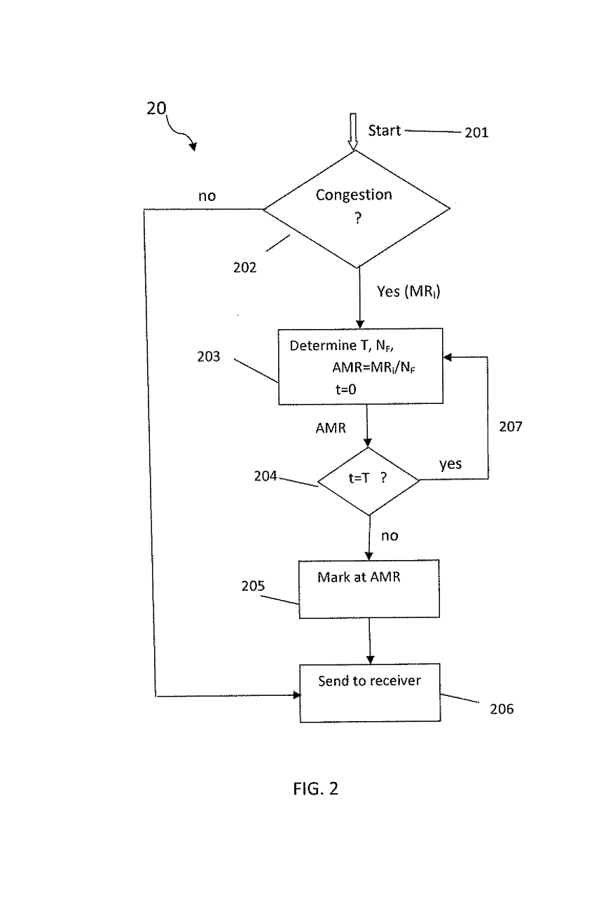

The method is depicted in a flow chart shown in FIG. 2 for the situation shown in FIG. 1.

The method starts with operation 201, which send data from a plurality of transmitting servers 14 to each of the corresponding input port 12a of switch 12 which controls transmission of data packets to receiving server 11.

The input buffers, e.g. buffer 12a′ of port 12a send their data packet content into output buffer 12b′ of output port 12b and the method proceeds to stage 202 in which output buffer 12b′ is continuously monitored for congestion.

If congestion is detected an initial marking rate is MRᵢ is assigned in accordance to the Congestion Marking Function of the Congestion Control Agent included in firmware 12c of switch 12. In the absence of congestion the method goes to stage 206.

The method then continues with stage 203 in which a time interval T and the instant number of data flows N_{F} between input buffers 12a and output buffer 12b of switch 12 are determined, in addition an adaptive marking rate AMR is assigned in accordance to AMR=MRᵢ/N_{F}.

Marking proceeds at AMR as shown in stage 205 and switch 12 sends marked and unmarked data packets to destination server 11 as long as the time period T since previous N_{F} determination is not exceeded, this is shown in stage 206.

After period T has been reached, an updated number of data flows N_{F} is determined as shown in stage 207, time is reset to 0 and AMR is updated accordingly.

Periodically, also the value of MRᵢ is adjusted in accordance to the congestion status of switch 12. This stage which is not shown in FIG. 2 affects too the value of AMR.

The following stages are known in the art and are not shown in FIG. 2.

After operation 206, the receiving server analyses the data packets to determine if the packet was marked to indicate congested data.

Upon receiving of a marked packet the destination server generates a BECN and by use of information contained within the data packet header, the BECN is directed through switch 12 and sent to the appropriate source server from which the packet originally emerged thus reducing its transmission rate.

An IB switch which enables the adaptive marking rate in accordance to the present invention will now be described:

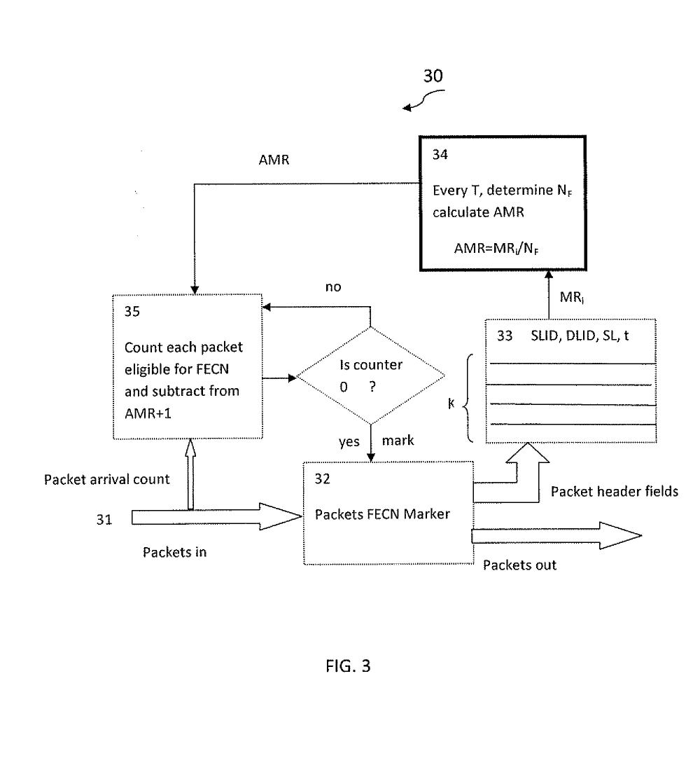

In switch 30 shown in FIG. 3, existing components are designated as boxes having dotted lines.

Switch 30 includes a packet FECN marker 32, a Congestion Control Agent (CCAg) 33 and a counter 35. CCAg 33 includes a FIFO of K entries each of which provides within a predetermined adjustable period of time t, a Source Local Identification (SLID), a Destination Local Identification (DLID) and the Service Level (SL) which are extracted from the headers of packets marked with FECNs.

When a stream of packets 31 originating from a plurality of source servers (not shown) arrives, CCAg 33 handles the incoming stream and delivers the mentioned above information in a FIFO order to unit 34.

Unit 34 determines each T, according to SLID, DLID and SL obtained, the number of data flows N_{F} from the source ports (not shown) to the single destination port (not shown) and calculates accordingly an adaptive value to packets between marking (AMR) wherein:

AMR=MRᵢ/N_{F}

A value of AMR is delivered to a cyclic counter 35 which was reset to 0 and that for each packet arrival, its count increases by a unit and is subtracted from the value of AMR+1.

When 0 is obtained as a result of said subtraction after a particular packet arrival, packet FECN marker 32 marks that packet which is then sent to its destination server (not shown) together with the unmarked packets.

Each time interval T, the value of N_{F} is updated and the value of AMR is adjusted by unit 34.

The CCM may send an update to the value of MRᵢ which in turn is updated by unit 33 and delivered to unit 34, this affect the value of AMR as well.

### EXAMPLE

A non limiting example which demonstrates the utility of the present invention in alleviating traffic congestion via a 3 level fat tree built from 12 switches of 8 ports, using a single set of CC parameters is given below.

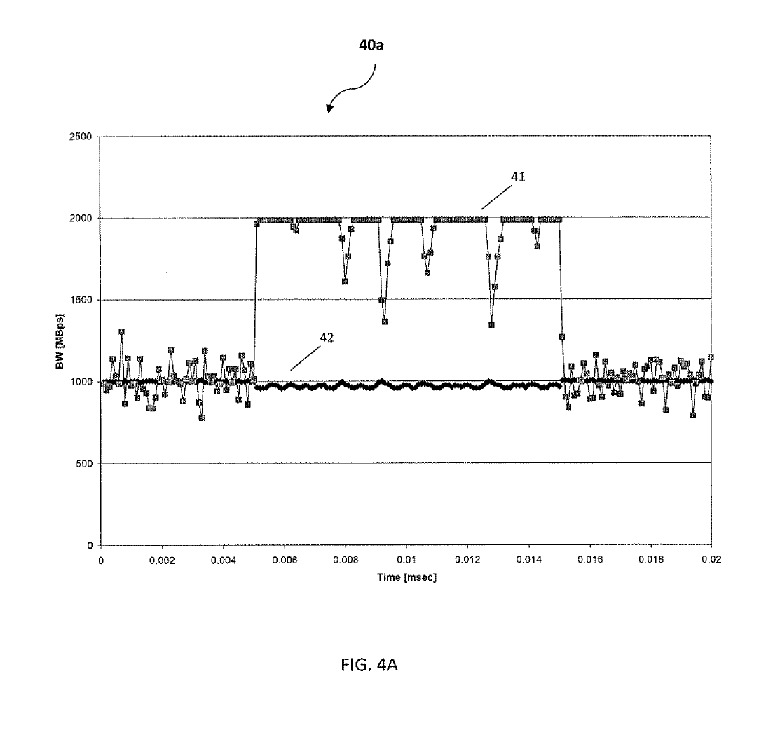

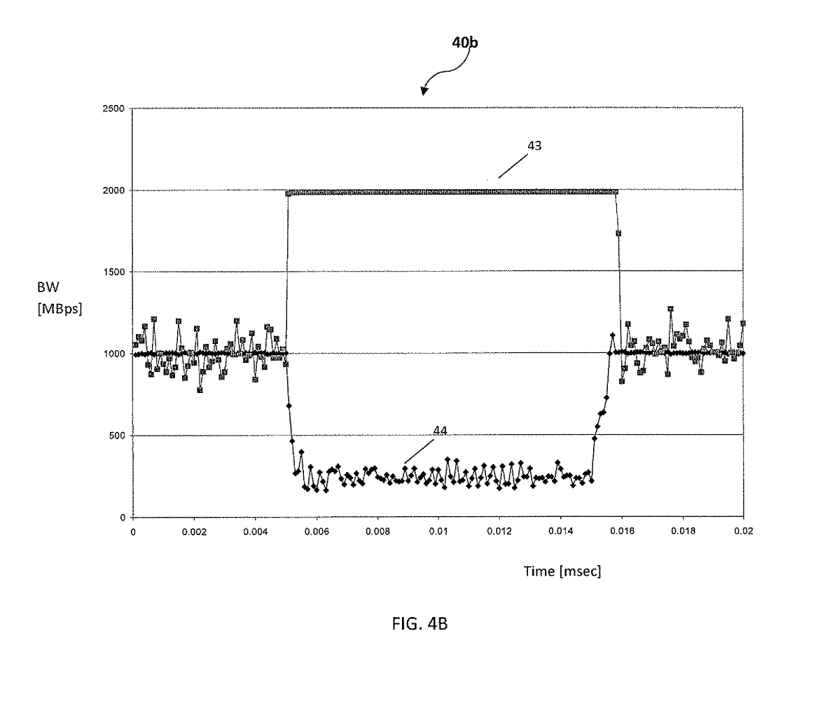

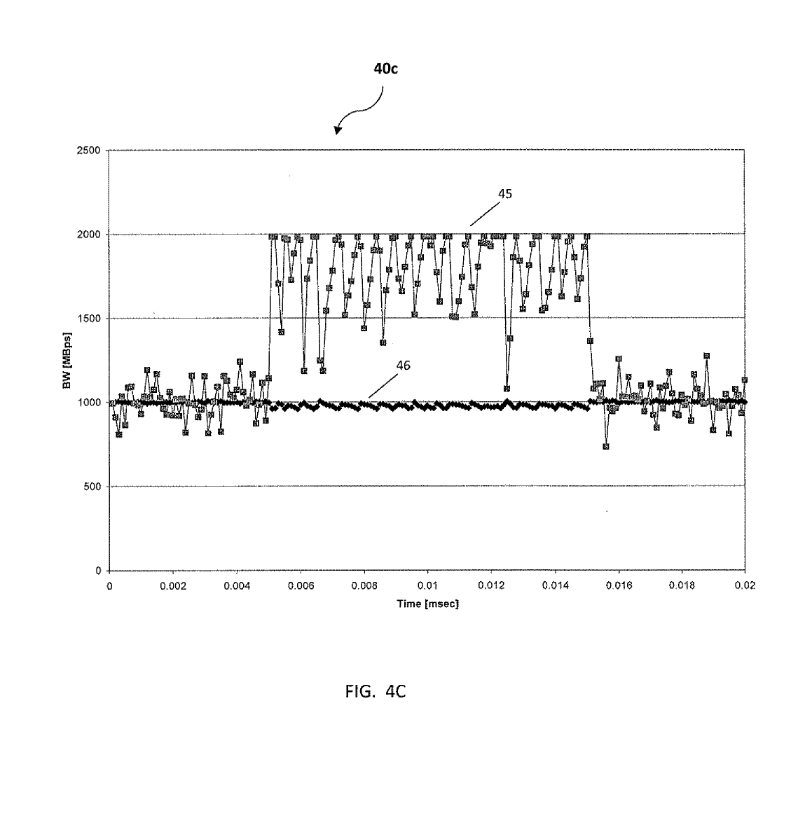

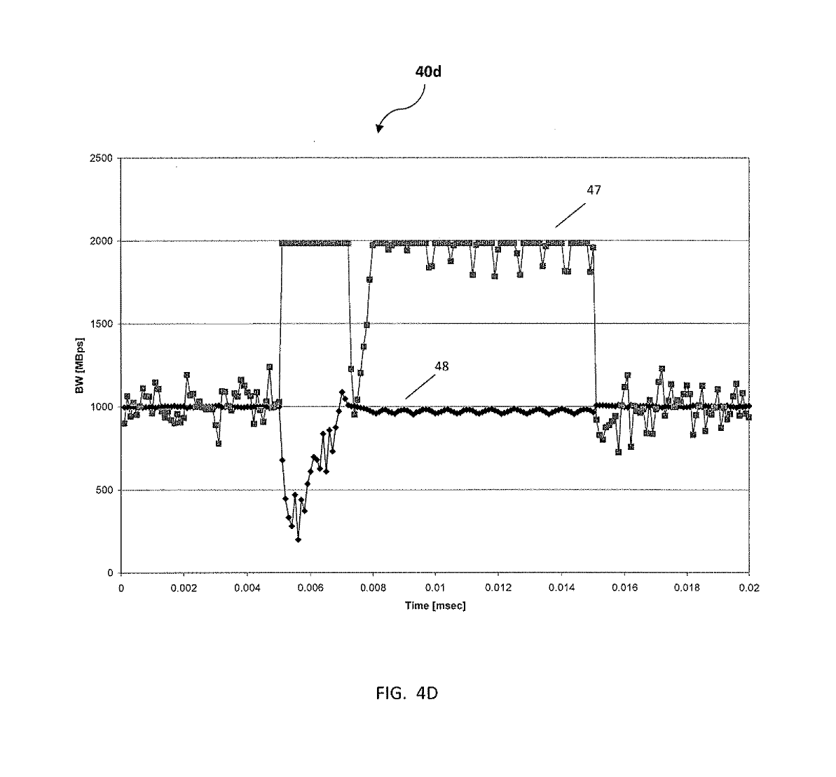

Graphs 40a, 40b, 40c and 40d in FIGS. 4A, 4B, 4C and 4D respectively are simulation results of traffic bandwidth (BW) for data packet transfer through an InfiniBand fat tree connecting 32 hosts which are capable of injecting and receiving packets at an average rate of 1980 MBytes per second.

These graphs show two types of experiments: “2 to 1” and “32 to 1” which represent congestion caused by 2 or 32 hosts sending data to a host number 1, respectively. In both experiments the hosts send data at a rate which is about a half of their capability that is 1000 MBytes per second. The start and stop times for the congestion are also common, the congestion starts after 5 msec. and ends after 15 msec from the beginning of the experiment.

During the entire experiment all hosts send data to random destinations if they are not busy sending to host number 1 (either due to the CC throttling or if they are not required to participate in the congesting traffic). This kind of random traffic is called “background traffic”.

Each graph shows two curves: the hot spot (host number 1) incoming BW and the average background traffic (hosts 2 to 32) incoming BW.

System behavior without the present invention, when a constant marking rate of 20 is applied at the switches is shown in graphs 40a and 40b:

Graph 40a in FIG. 4A shows the results of the simulation for the “2 to 1” experiment, in which host number 1 receives data packet from two nodes only. Curve 41 in graph 40a shows traffic BW flowing into node 1. Curve 42 in graph 40a shows the average background traffic BW flowing into nodes 2 to 32 of the same experiment. As may be noticed, once the congestion period starts, the BW on host number 1 increases to its maximal value of 1856 MBytes per second while the background traffic is unaffected.

Graph 40b in FIG. 4B shows the results of the simulation for the “32 to 1” experiment, in which host number 1 receives data packet from all nodes. Curve 43 in graph 40b shows traffic BW flowing into node 1. Curve 44 in graph 40b shows the average background traffic BW flowing into nodes 2 to 32 of the same experiment. As may be noticed, once the congestion period starts, the BW on host number 1 increases to its maximal value of 1980 MBytes per second, however the average background BW drops due to congestion spreading which is caused by lack of BECN flow into the hosts caused by the constant marking rate of 20.

System behavior in accordance with the present invention, when an adaptive marking rate between 1 and 20 is applied at the switches is shown in graphs 40e and 40d:

Graph 40c in FIG. 4C shows the results of the simulation for the “2 to 1” experiment, in which host number 1 receives data packet from two nodes only. Curve 45 in graph 40c shows traffic BW flowing into node 1. Curve 46 in graph 40c shows the average background traffic BW flowing into nodes 2 to 32 of the same experiment. As may be noticed, once the congestion period starts, the BW on host number 1 increases to its maximal value of 1856 MBytes per second while the background traffic is un-affected.

Graph 40d in FIG. 4D shows the results of the simulation for the “32 to 1” experiment, in which host number 1 receives data packet from all nodes. Curve 47 in graph 40c shows traffic BW flowing into node 1. Curve 48 in graph 40d shows the average background traffic BW flowing into nodes 2 to 32 of the same experiment. As may be noticed, once the congestion period starts, the BW on host number 1 increases to its maximal value of 1980 MBytes per second. With an adaptive marking rate applied at the switches the average background BW drops only momentarily and recovers to the maximal value of 1856 MBytes per sec.

While the invention has been described with respect to a limited number of embodiments, it will be appreciated that many variations, modifications and other applications of the invention may be made without departing from the spirit and scope of the invention.

It should be understood that the source of data packet of the present invention may be any type of device which can send data packets such as for example, a target channel adaptor a switch or a data storage device. It should also be understood that the recipient of data may be any device which may receive data packets such as for example, a host adaptor or a second switch.

The present invention is not limited to a fabric with a single switch, or to a switch serving a single receiving server, or to a single output of a switch, rather it can be extended to a network including a plurality of switches and receiving devices wherein in such configurations, the appropriate modification of the invention has to be made without departing from the scope of the invention.

It should also be appreciated that the invention is not limited to any particular marking mechanism or method of handling marked packet by the switch.

What is claimed is:

1. A method for adaptive congestion control in an InfiniBand (IB) fabric, the fabric including a plurality of transmitting devices that transmit packets of data to a receiving device through a switch, comprising the stages of:
(a) sending data from at least one transmitting device among the plurality of the transmitting devices via at least one input port of the switch, said data is transferred to an output buffer of an output port of the switch which is connected to the receiving device,
(b) monitoring continuously for data congestion in said output buffer of said switch and allocating a value for an initial marking rate (MRᵢ) by a Congestion Control Manager,
(c) determining the number of data flows-N_{F} to said output buffer of said switch,
(d) calculating a value for an adaptive marking rate (AMR), said value of AMR depends on said value of MRᵢ and on N_{F}, and
(e) marking data packets in accordance to said adaptive marking rate.

2. The method as in claim 1 further comprising the stages of:
(f) associating a BECN to said marked data packets by the receiving device and sending said BECN to said transmitting devices from which the data packet has been sent respectively, and
(g) adjusting the data transmitting rate of each of the transmitting devices in accordance to arrival rate of said BECN.

3. The method as in claim 1 wherein said data congestion is detected when a threshold in the occupancy of said data packets in said output buffer of said output is reached.

4. The method of claim 1 wherein said AMR is inversely proportional to N_{F}.

5. The method as in claim 4 wherein said AMR is calculated by the following equation: AMR=MRᵢ/N_{F}

6. The method as in claim 2 wherein said BECN is associated with an acknowledgement (ACK) returned by the receiving device.

7. The method as in claim 1 wherein MRᵢ has a value between 0 and 2¹⁶.

8. The method as in claim 1 wherein said N_{F} is between 1 to 100.

9. The method as claim 1 wherein the switch is selected from the group consisting of a single switch and a multiple switch.

10. The method as in claim 1 wherein said transmitting device is selected from the group consisting of a target channel adaptor, a multiple target adaptor, a switch and a multiple switch.

11. The method as in claim 1 wherein said receiving device is selected from the group consisting of a host adaptor and a switch.

12. A switch in an InfiniBand (IB) fabric connecting between a plurality of transmitting devices and at least one receiving device comprising of:
(a) a plurality of input ports to which the transmitting devices are connected and at least one output port to which the receiving device is connected,
(b) a Congestion Control Manager (CCM) to analyze data packets, to monitor data congestion at said at least one output port as a result of arrival rate of said incoming data packets and to determine an initial value to a marking rate (MRᵢ),
(c) a mechanism which determines after each selected time interval, the number of data flows N_{F} between said plurality of input ports and said at least one output port and which calculates accordingly an adaptive value for said marking rate (AMR), and
(d) a data packet FECN marker which marks data in accordance to said AMR value.

13. The switch as in claim 12 further comprising of:
(e) a second mechanism to deliver both marked and unmarked said incoming data packets to said receiving device and,
(f) a third mechanism to return a BECN generated due to said marked packets to the transmitting device among said plurality of transmitting devices from which said data packet originated.

14. The switch as in claim 12 wherein said value of AMR is inversely proportional to N_{F}.

15. The switch as in claim 14 wherein said value of AMR value is calculated according to the equation: AMR=MRᵢ/N_{F}.

16. The switch as in claim 12 wherein said data congestion is detected when a threshold in a number of stored said data packets in an output buffer of said output port is reached.

17. The switch as in claim 10 wherein said MRᵢ value is between 0 and 2¹⁶.

18. The switch as in claim 10 wherein said N_{F} is between 1 to 100.

19. The switch as in claim 10 wherein said selected time interval is between about 1 to 1000 μsec.

20. The switch as in claim 10 wherein each of sent back BECN is associated with a data receiving acknowledgement (ACK).

21. The switch as in claim 1 wherein said transmitting devices are selected from the group consisting of a channel target adaptor, a multiple target adaptors, a switch and multiple switches.

22. The switch as in claim 10 wherein said receiving device is selected from the group consisting of a host adaptor and a second switch.

23. An Inifiniband system for data transfer comprising:
(a) at least one transmitting device among a plurality of transmitting devices which transmit data packets,
(b) at least one receiving device which receives said transmitted data packets and,
(c) at least one switch connecting between said plurality of transmitting device and said at least receiving device, wherein said switch upon detecting data congestion identifies the number of data flows-N_{F} between said plurality of transmitting devices and said at least one receiving device and marks said incoming data packets with a marking rate having a value which is inversely proportional to N_{F}.

24. The system as in claim 20 wherein each said marked data packet generates a BECN.

25. The system as in claim 21 wherein the transmitting devices are configured to decrease data transmission rate in accordance to the rate of receiving BECN.
